(19) United States
(12) Patent Application Publication
(10) Pub. No.: US 2009/0114207 A1
(43) Pub. Date: May 7, 2009

(54) Portable Barbecue Device

(76) Inventor: William Koshelanyk, Traverse Bay (CA)

Correspondence Address: ADE & COMPANY INC., 2157 Henderson Highway, WINNIPEG, MB, R2G1P9, CA

(21) Appl. No.: 12/262,263

(22) Filed: Oct. 31, 2008

Related U.S. Application Data
(60) Provisional application No. 60/984,947, filed on Nov. 2, 2007.

(51) Int. Cl. A47J 37/06

(52) U.S. Cl. 126/25 R

(57) ABSTRACT

A portable barbeque device comprises an exterior housing for being supported on a wheeled chassis and having a door supporting an appliance housing thereon. The appliance housing comprises a base and a pivotal lid arranged to define a cooking chamber therein. A gas burner supported on the base provides heat to the cooking chamber for barbecuing. The exterior housing surrounding the appliance housing is well suited for mounting on the exterior of various types of vehicles while the appliance housing remains protected during transport. Vibration isolating mounts between the appliance housing and the exterior housing isolate the appliance housing and burner therein from road vibrations during transport.

This application claims the benefit under 35 U.S.C. 119(e) of U.S. provisional application Ser. No. 60/984,947, filed Nov. 2, 2007.

### FIELD OF THE INVENTION

The present invention relates to a portable barbeque device, and more particularly relates to a barbeque device arranged to be supported on a chassis of a trailer or vehicle within a protective housing.

### BACKGROUND

Barbequing is a popular and desirable cooking method for many individuals, however it is difficult to do when traveling as conventional barbeque appliances are not readily portable. Particularly for highway truck tractor drivers, there is often little space to store a portable gas barbeque appliance in a manner which is secure and protected from the elements.

The following US patents disclose various examples of cooking appliances related to vehicles. U.S. Pat. No. 6,637,426 belonging to Champlin; U.S. Pat. No. 6,263,867 belonging to Skelton; U.S. Pat. No. 5,263,467 belonging to Jones; U.S. Pat. No. 6,354,286 belonging to Davis; U.S. Pat. No. 5,586,546 belonging to Ashcraft et al.; and U.S. Pat. NO. 1,372,419 belonging to Grant.

None of the prior art devices are particularly suited for attachment to any type of vehicle, and more particularly a highway truck tractor in a manner in which the appliance is both secured to the vehicle against road vibrations as well as being protected from the weather and elements.

### SUMMARY OF THE INVENTION

According to one aspect of the invention there is provided a portable barbeque device for being supported on a wheeled chassis, the device comprising:

an exterior housing comprising:

a plurality of walls surrounding a hollow interior of the exterior housing and having a door opening therein; and

a door supported for pivotal movement between an open position in which the hollow interior is accessible through the door opening and a closed position in which the door spans the door opening such that the hollow interior is enclosed by the walls and the door;

mounting means for supporting the exterior housing on the wheeled chassis;

an appliance housing arranged to be received in the hollow interior of the exterior housing in the closed position of the door, the appliance housing comprising a base and a lid pivotally supported on the base for movement between a closed position defining a cooking chamber enclosed by the base and the lid and an open position in which the cooking chamber is accessible;

a gas burner supported on the base of the appliance housing in the cooking chamber;

a gas source for supplying gaseous fuel to the gas burner.

By providing a barbeque device having an appliance housing with a cooking chamber therein which is in turn received within an exterior housing mountable on the wheeled chassis, the device can be mounted on the exterior of various types of vehicles while the appliance housing remains protected from the elements for transport. The exterior housing is particularly suited for mounting on a highway truck tractor unlike any of the prior art cooking appliances which are known. By arranging the mounting bracket of the exterior housing which supports the housing on the vehicle to be readily releasable, the housing is well suited for attachment to any number of different vehicles. By providing vibration isolating mounts between the appliance housing and the exterior housing, the appliance housing can be secured and isolated from road vibrations while at the same time the mounts can be arranged to maintain the lid of the appliance housing in a secure enclosed position within the exterior housing.

The mounting means may comprise a releasable bracket arranged for detachment and reattachment of the exterior housing to the wheeled chassis.

The appliance housing is preferably supported on the exterior housing by vibration isolating mounts.

The appliance housing may be supported on an interior surface of the door of the exterior housing.

The appliance housing may be supported on an interior surface of the door of the exterior housing by vibration isolating mounts.

Preferably there is provided vibration isolating mounts supported on a rear wall of the housing opposite the door opening within the hollow interior of the exterior housing which are arranged to be engaged with the lid of the appliance housing and to retain the lid of the appliance housing in the closed position when the door of the exterior housing is in the closed position.

When the housing extends in a longitudinal direction between opposed end walls, the door opening preferably extends across a front side of the housing between the opposed ends, and the door is preferably pivotal about a door axis oriented parallel to the longitudinal direction.

The lid of the appliance may be pivotal relative to the base about a lid axis oriented parallel to the longitudinal direction of the housing.

There may be provided an auxiliary compartment spanning one of the end walls within the hollow interior of the exterior housing, an opening of the auxiliary compartment arranged to be enclosed by the door in the closed position of the door.

The appliance housing is preferably supported on the exterior housing to be offset in the longitudinal direction towards the end wall of the housing opposite the auxiliary compartment.

There may be provided a perimeter sealing member about a perimeter of the door for sealing between the door and the walls of the exterior housing in the closed position of the door.

There may be provided an internal storage compartment within the hollow interior of the exterior housing having an opening which lies generally in a plane of the door opening so as to be enclosed by the door in the closed position of the door.

Preferably there is provided a grill supported fixedly on the base spaced above the gas burner, and a material having a high heat capacity fixedly supported between the burner and the grill.

There may be provided a shutoff valve coupled in series between the gas source and the gas burner which is arranged to be shutoff responsive to the door of the exterior housing being displaced into the closed position.

The device may be provided in combination with a highway truck tractor supporting the exterior housing on a frame thereof or in combination with a highway truck tractor trailer having a frame upon which the exterior housing is supported.

One embodiment of the invention will now be described in conjunction with the accompanying drawings in which:

### BRIEF DESCRIPTION OF THE DRAWINGS

FIG. 1 is a schematic side elevational view of a highway truck tractor upon which the device is supported.

FIG. 2 is a schematic perspective view of the portable barbecue device.

FIG. 3 is a front elevational view of the exterior housing in the closed position.

FIG. 4 is a front elevational view of the exterior housing in the closed position in which the appliance housing and an auxiliary compartment are schematically illustrated in relation to the exterior housing.

FIG. 5 is a partly sectional side elevational view of the device with both the exterior housing and the appliance housing received therein being in a closed position.

FIG. 6 is a front elevational view of the device with the exterior housing shown in an open position of the door.

FIG. 7 is a side elevational view of the device with the door of the exterior housing in the open position.

FIG. 8 is a side elevational view of the door of the exterior housing in an open position with the lid of the appliance housing also being in an open position.

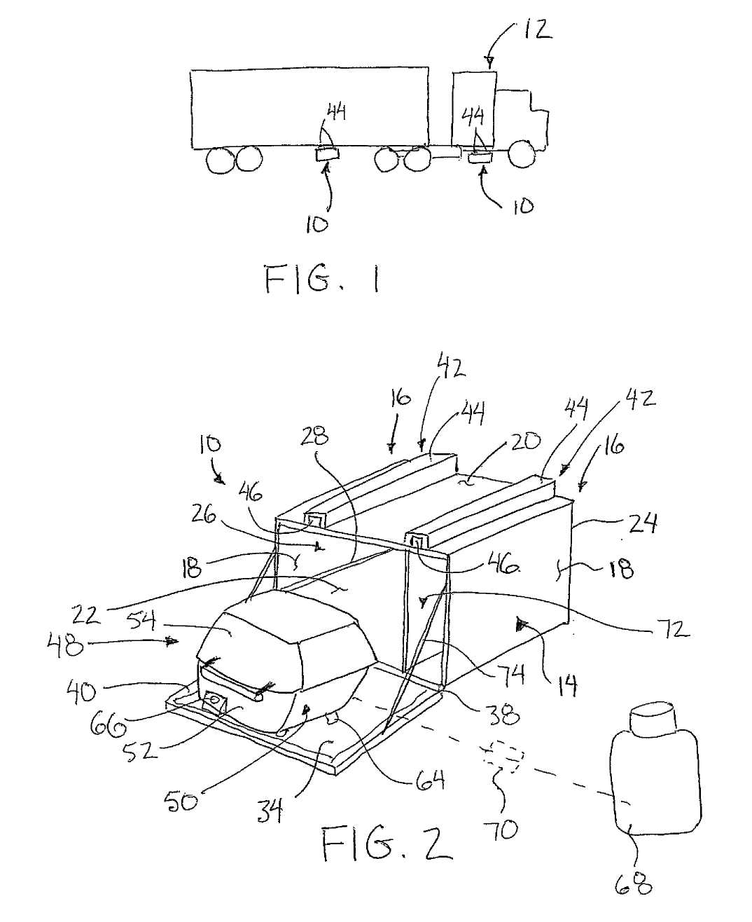

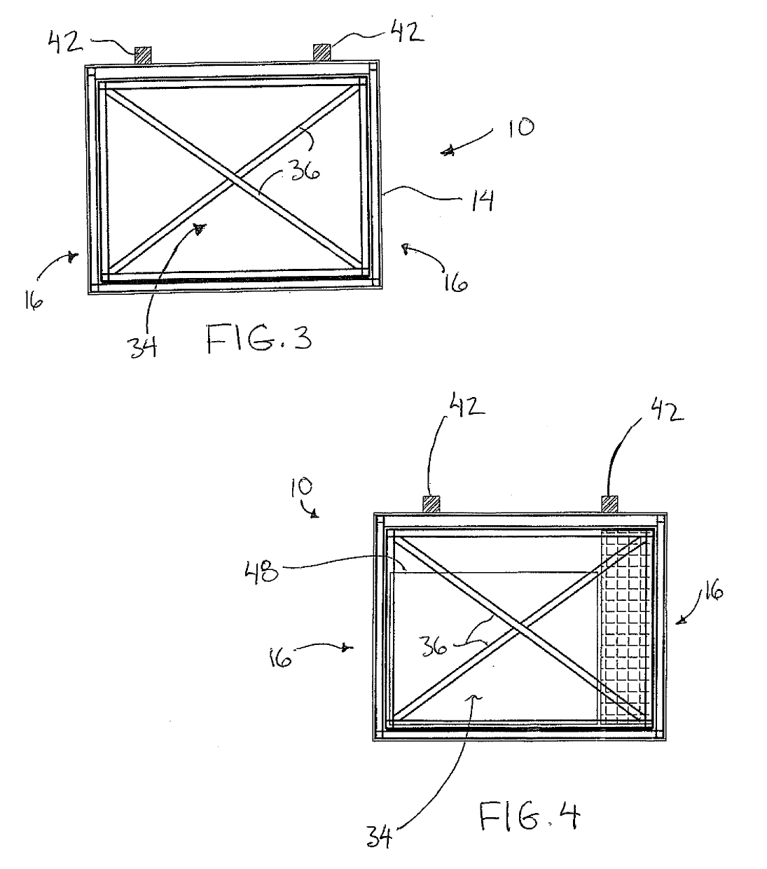

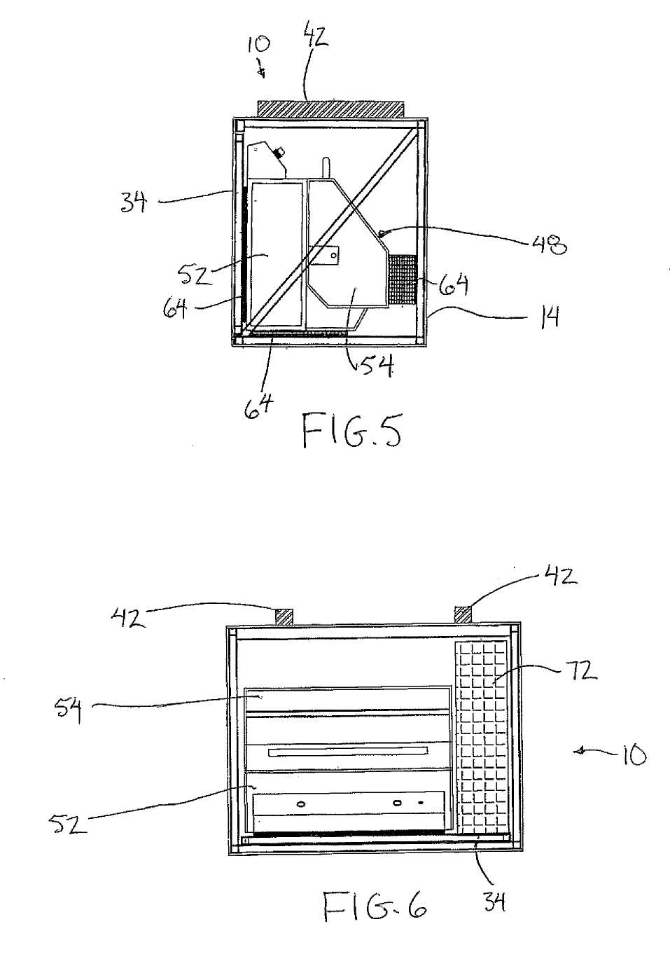

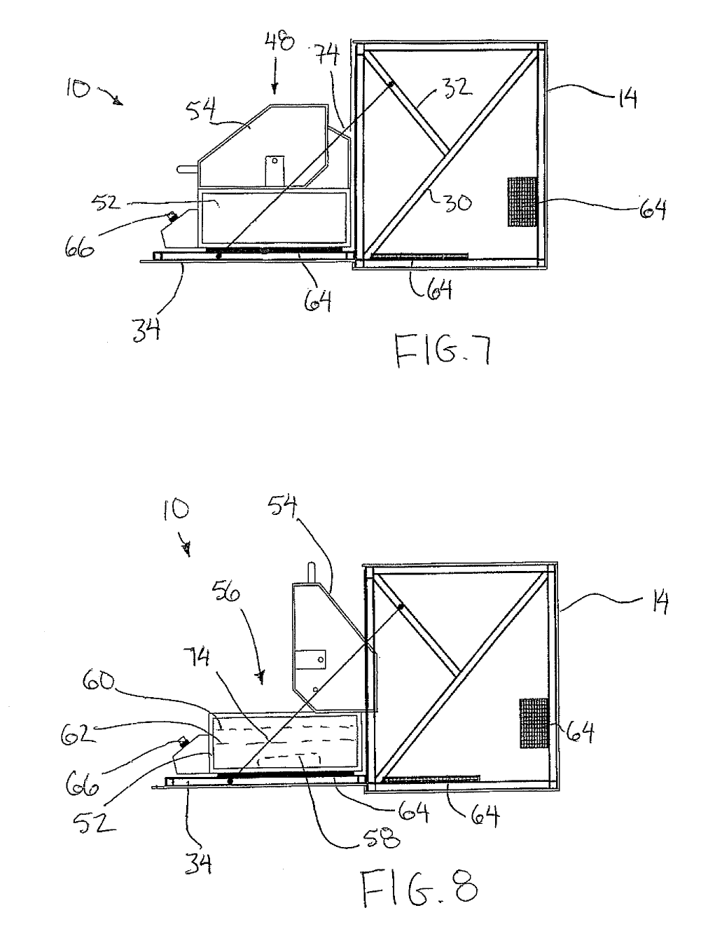

In the drawings like characters of reference indicate corresponding parts in the different figures.

### DETAILED DESCRIPTION

Referring to the accompanying figures there is illustrated a portable barbeque device generally indicated by reference numeral 10. The device 10 is particularly suited for being supported on a wheeled chassis 12 supported on wheels for rolling movement along the ground, for example a chassis of a highway truck tractor or a trailer as shown in the accompanying figures.

The device 10 includes an exterior housing 14 which is generally rectangular in shape and elongate in a longitudinal direction extending between two opposed ends 16. The housing 14 includes two end walls 18 located at the ends 16 so as to be parallel and spaced apart from one another in a vertical orientation perpendicular to the longitudinal direction of the housing. The housing further includes a top wall 20 and a bottom wall 22 which extend horizontally between the opposed ends 16 parallel and spaced one above the other to span generally horizontally between front and rear sides of the housing. A rear wall 24 spans the rear side of the housing in a vertical direction between the top and bottom walls of the housing. The rear wall 24 also spans in a vertical plane in the longitudinal direction between the opposed ends 16.

The front side 26 of the housing opposite the rear wall 24 defines a door opening which spans the full length of the housing between the opposed ends 16 and the full height thereof between the top and bottom walls.

The exterior housing 14 includes an internal frame comprised of a plurality of frame members 28 extending along each of the corner edges of the housing to form four vertical posts as well as extending about the perimeter of the top and bottom walls. The internal frame members also include first diagonal supports 30 which extend diagonally across the end walls 18 so that each first diagonal support extends upwardly and rearwardly from a bottom front corner of the end wall to a top rear corner of the end wall. A second diagonal support 32 connects between a midpoint of the first diagonally support upwardly and forwardly to an upper front corner at each of the end walls 18. Suitable sheet metal spans the internal frame to define each of the walls of the housing.

A door 34 is provided for spanning the front side of the opening when the door is closed. The door 34 comprises a perimeter frame of rigid frame members similar to the housing across which sheet metal spans. A pair of diagonal supports 36 span between each pair of diagonally opposed corners of the door to provide additional structural support to the perimeter frame of the door 34. A hinge 38 extends in the longitudinal direction along the bottom rear side of the door 34 which corresponds to the front lower edge of the door opening to define the door axis about which the door 34 pivots. The door axis lies parallel to the longitudinal direction of the housing.

The door 34 is pivotal between an open position in which the door extends horizontally forward from the lower edge of the door opening to provide access through the door opening to the hollow interior of the exterior housing 14. The doors is pivotal from the open position to a closed position in which the door 34 spans the door opening so that the door and the walls of the exterior housing together fully enclose the hollow interior thereof.

A perimeter seal 40 is provided about the periphery of the door 34 for engaging the periphery of the door opening formed by the walls of the exterior housing to provide a sealed connection between the door and the walls of the housing when the door is in the closed position. The seal may comprise neoprene or any other suitable sealing member which provides some weather proofing to protect the hollow interior of the exterior housing 14 from the weather and the elements.

Mounts 42 are provided on the top wall of the housing at longitudinally spaced positions for securing exterior housing to the chassis 12. Each of the mounts 42 comprises a first bracket 44 which is arranged to be welded to the chassis of either a truck tractor or a trailer towed by a highway truck tractor as shown in FIG. 1. The mounts each further include a second bracket 46 fixed to the top wall of the exterior housing which is arranged for selective connection to the first brackets respectively. Connection between the first and second brackets is arranged to be readily releasable to provide a quick release or quick connect connection therebetween which selectively mounts the exterior housing onto the vehicle for subsequent separation and reattachment is desired.

A gas barbeque appliance 48 is mounted on an inner surface of the door 34 and is arranged for pivotal movement with the door between the open and closed positions thereof. In the closed position of the door, the appliance 48 is arranged to be received fully within the hollow interior of the exterior housing to be enclosed therein by the closed door.

The appliance 48 comprises an appliance housing 50 which includes a base 52 and a lid 54 pivotally coupled to the base. The base 52 comprises a floor and walls extending upwardly about a perimeter of the floor to define part of a cooking chamber 56 therein. The base 52 provide access to the cooking chamber 56 therein through a top side of the base when the lid 54 is pivoted to an open position.

The lid 54 comprises a top wall and a plurality of depending sides which meet the sides of the base 52 when the lid 54 is in a closed position to fully surround and enclose the cooking chamber 56 between the base and the lid. The lid 54 is hinged onto the base 52 about a lid axis which is parallel to the axis of the door 34 and the longitudinal direction of the housing. The lid 54 and the base 52 coupled to one another along respective rear edges thereof such that the lid is pivotal between a closed position in which the top wall of the lid is generally horizontal and parallel to the floor of the base 52 with the cooking chamber 56 being enclosed between the base and the lid, and an open position in which the lid is pivoted upwardly and rearwardly in relation to the base to provide access to the hollow interior cooking chamber of the appliance.

The cooking chamber 56 includes a gas burner 58 located therein which is supported on the base 52 spaced above the floor thereof. A grill 60 is supported spaced above the gas burner 58 also on the base with a high heat capacity material 62 being located above burner and below the grill so as to be located between the burner and the grill in fixed relation to the base for defusing heat from the burner to the surrounding cooking chamber.

Vibration isolating mounts 64 are provided which couple the base 52 of the applicant to the inner surface of the door 34 to isolate road vibrations from being transmitted therebetween. When the lid of the appliance housing is closed and the door of the exterior housing is closed, additional vibration isolating mounts 64 which are fixed on the rear wall of the exterior housing on the interior surface thereof, are arranged to engage the lid and hold the lid in a closed position clamped between the mounts 64 on the rear wall and the base supported on the mounts 64 of the inner surface of the closed door 34. The vibration isolating mounts 64 may comprise a high density foam, or other suitable resilient material which can resist transferring vibrations therethrough and which is heat resistant to resist damage when exposed to the normal operating temperatures of the barbeque appliance.

Suitable controls 66 are provided at the front side of the base 52 of the appliance which include valves for controlling the amount of fuel delivered to the burns and which permit igniting of the fuel.

The exterior housing may be provided with a lock to restrict opening of the housing from the closed position by unauthorized persons.

A gas source 68 is provided separately from the exterior housing 14 and is arranged to supply the burner with gaseous fuel. A shutoff valve 70 is coupled in series between the gas source 68 and the burners 58 which is arranged to be automatically shutoff of closed responsive to the door of the exterior housing being closed.

The appliance is supported on the door 34 to be offset in the longitudinal direction of the housing closer to one end of the housing. The opposing end 16 locates an auxiliary compartment 72 adjacent thereto which spans the hollow interior at the end of the housing fully between the front and back sides of the housing and the top and bottom walls of the housing. The compartment 72 is open at the front side and provides access therein for storing utensils of other equipment related to the barbecuing appliance. The door 34 is arranged to span the open front side of the auxiliary compartment 72 in the closed position to also enclose the auxiliary compartment when enclosing the interior of the exterior housing 14.

A link member 74 is coupled between the door 34 at one end thereof spaced from the hinge axis to a second diagonal support 32 at the corresponding end of the housing. The link member 74 is arranged to be supported under tension between the door and the walls of the exterior housing 14 when the doors in the open position to prevent further pivotal movement of the door away from the closed position beyond the open position.

In some embodiments, the exterior housing may have a lateral dimension to extend in the longitudinal direction of travel of the vehicle which is in the range of 2 to 3 feet. When configured for mounting directly onto a highway truck tractor instead of a trailer, the exterior housing is preferably only 2 feet wide in the longitudinal direction of travel of the vehicle for optimal placement of the vehicle.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A portable barbeque device for being supported on a wheeled chassis, the device comprising:
an exterior housing comprising:
a plurality of walls surrounding a hollow interior of the exterior housing and having a door opening therein; and
a door supported for pivotal movement between an open position in which the hollow interior is accessible through the door opening and a closed position in which the door spans the door opening such that the hollow interior is enclosed by the walls and the door;
mounting means for supporting the exterior housing on the wheeled chassis;
an appliance housing arranged to be received in the hollow interior of the exterior housing in the closed position of the door, the appliance housing comprising a base and a lid pivotally supported on the base for movement between a closed position defining a cooking chamber enclosed by the base and the lid and an open position in which the cooking chamber is accessible;
a gas burner supported on the base of the appliance housing in the cooking chamber;
a gas source for supplying gaseous fuel to the gas burner.

2. The device according to claim 1 wherein the mounting means comprise a releasable bracket arranged for detachment and reattachment of the exterior housing to the wheeled chassis.

3. The device according to claim 1 wherein the appliance housing is supported on the exterior housing by vibration isolating mounts.

4. The device according to claim 1 wherein the appliance housing is supported on an interior surface of the door of the exterior housing.

5. The device according to claim 1 wherein the appliance housing is supported on an interior surface of the door of the exterior housing by vibration isolating mounts.

6. The device according to claim 1 wherein there is provided vibration isolating mounts supported on a rear wall of the housing opposite the door opening within the hollow interior of the exterior housing which are arranged to be engaged with the lid of the appliance housing and to retain the lid of the appliance housing in the closed position when the door of the exterior housing is in the closed position.

7. The device according to claim 1 wherein the housing extends in a longitudinal direction between opposed end walls, the door opening extends across a front side of the housing between the opposed ends, and the door is pivotal about a door axis oriented parallel to the longitudinal direction.

8. The device according to claim 7 wherein the lid of the appliance is pivotal relative to the base about a lid axis oriented parallel to the longitudinal direction of the housing.

9. The device according to claim 7 wherein there is provided an auxiliary compartment spanning one of the end walls within the hollow interior of the exterior housing, an opening of the auxiliary compartment arranged to be enclosed by the door in the closed position of the door.

10. The device according to claim 9 wherein the appliance housing is supported on the exterior housing to be offset in the longitudinal direction towards the end wall of the housing opposite the auxiliary compartment.

11. The device according to claim 1 wherein there is provided a perimeter sealing member about a perimeter of the door for sealing between the door and the walls of the exterior housing in the closed position of the door.

12. The device according to claim 1 wherein there is provided an internal storage compartment within the hollow interior of the exterior housing having an opening which lies generally in a plane of the door opening so as to be enclosed by the door in the closed position of the door.

13. The device according to claim 1 wherein there is provided a grill supported fixedly on the base spaced above the gas burner, and a material having a high heat capacity fixedly supported between the burner and the grill.

14. The device according to claim 1 wherein there is provided a shutoff valve coupled in series between the gas source and the gas burner which is arranged to be shutoff responsive to the door of the exterior housing being displaced into the closed position.

15. The device according to claim 1 in combination with a highway truck tractor supporting the exterior housing on a frame thereof.

16. The device according to claim 1 in combination with a highway truck tractor trailer having a frame upon which the exterior housing is supported.
